(19) United States
(12) Patent Application Publication
(10) Pub. No.: US 2007/0000750 A1
(43) Pub. Date: Jan. 4, 2007

(54) Sheet identification apparatus

(75) Inventors: Teruhiko Uno, Tokyo (JP); Ryuuji Higashi, Kanagawa-ken (JP); Masahito Kochiwa, Kanagawa-ken (JP); Hidetake Suzuki, Kanagawa-ken (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/370,950

(22) Filed: Mar. 9, 2006

(30) Foreign Application Priority Data
Jun. 17, 2005 (JP) 2005-178086

(51) Int. Cl. G07D 7/00

(52) U.S. Cl. 194/207

(57) ABSTRACT

A sheet identification apparatus is equipped with a conveying means to convey sheets having sensory objects along the conveying path, a position detecting means to detect positions of sheets conveyed by the conveying means, a plurality of sensors arranged opposing to each other over almost full width in the direction orthogonal to the sheet conveying direction, and a controller to select a sensory object sensor that is capable of detecting the sensory object based on the position data detected by the position detecting means so as to detect the sensory object by the selected sensor.

### CROSS-REFERENCE TO RELATED APPLICATIONS

This application is based upon and claims the benefit of priority from the prior Japanese Application No. 2005-178086, filed on Jun. 17, 2005, the entire contents of which are incorporated herein by reference.

### FIELD OF THE INVENTION

The present invention relates to a sheet identification apparatus to detect sensory objects, for example, magnetic threads provided on sheets, for example, bank notes, etc. for identifying right or wrong, type, etc. of the sheets.

### DESCRIPTION OF THE RELATED ART

In the Japanese Patent Publication No. 1999-505353, a sheet identification apparatus to identify true or not, type of sheets by conveying sheets along the conveying path and detecting magnetic threads of the conveying sheets is disclosed as a sheet identification apparatus so far available.

However, in that example, there was such a defect that only one magnetic thread sensor was provided at the central portion of the conveying path and accordingly, if a sheet was conveyed in the skewed state, the whole or part of the magnetic thread of the sheet would come out of the detecting area of the magnetic thread sensor and the magnetic thread of the sheet could not be detected.

Further, there was also a defect that the magnetic thread could not be detected if a sheet is one-sided from the central portion.

Furthermore, when the magnetic thread is provided at the end of a sheet in the longitudinal direction and the sheet is conveyed in the state where its longitudinal direction crosses the conveying direction, the magnetic thread comes out of the detecting area of a magnetic thread sensor depending on the difference of front and back or the tilting degree.

### SUMMARY OF THE INVENTION

It is an object of the present invention to provide a sheet identification apparatus that is capable of certainly detecting the sensory object (magnetic thread) without being effected by the posture of a sheet or the sensory object on a sheet, for example, the position of the magnetic thread.

In order to achieve the object, a sheet identification apparatus of the present invention is characterized in that it is equipped with a conveying means to convey sheets having a sensory object along the conveying path, a position detecting means to detect the position of a sheet conveyed by the conveying means, a plurality of sensors arranged opposing to each other for almost whole width in the direction orthogonal to the sheet conveying direction of the conveying path, and a control means to select a sensory object sensor that is able to detect the sensory object based on the position data detected by the position detecting means and control the detecting means to detect the sensory object by this selected sensor.

Additional objects and advantages of the present invention will be apparent to persons skilled in the art from a study of the following description and the accompanying drawings, which are hereby incorporated in and constitute a part of this specification.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a construction diagram showing an embodiment of a sheet processing apparatus involved in the present invention;

FIG. 2 is a front view showing a sheet identification unit of the sheet processing apparatus shown in FIG. 1;

FIG. 3 is a plan view showing the sheet identification unit of the sheet processing apparatus shown in FIG. 1;

FIG. 4 is a graph showing the magnetic thread detection output by he detecting unit of the sheet processing apparatus shown in FIG. 1; and

FIG. 5 is a flowchart showing the magnetic thread detecting operation by the detecting unit shown in FIG. 4.

### DESCRIPTION OF THE PREFERRED EMBODIMENTS

A preferred embodiment of the present invention will be explained below in detail in reference to the attached drawings.

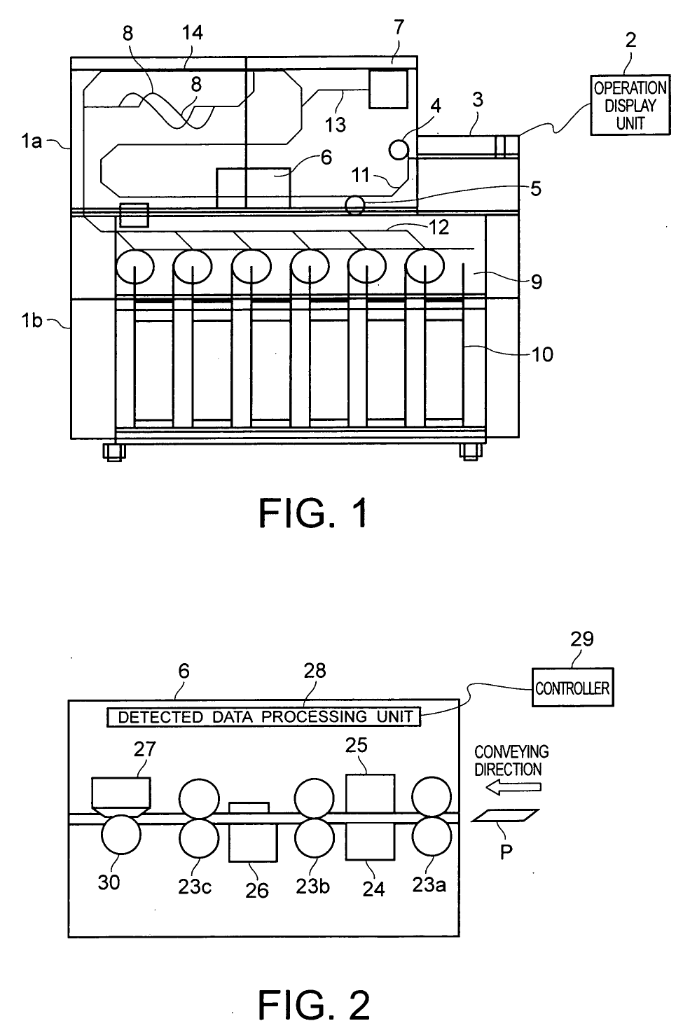

FIG. 1 is an embodiment of the sheet processing apparatus involved in the present invention.

The sheet processing apparatus shown in FIG. 1 is composed of an upper unit 1a, a lower unit 1b and an operation display unit 2. Upper unit la is provided with a main conveying path 11 to convey sheets and lower unit 1b is provided with a conveying path 12 to receive and convey sheets conveyed from upper unit 1a. Operation display unit 2 is provided with a touch panel for operator to make the input operation and a display to display various operating guides to operator. Lower unit 1b and upper unit la are so constructed as to operate according to job contents that are input through the touch panel of operation display unit 2.

On one side of upper unit 1a, a paper supply unit 3 is provided to supply sheets along the latitudinal direction. At the sheet supply end of sheet supply unit 3, a sheet take-in unit 4 is provided to take a sheet by one at a time and supply to a main conveying path 11. In this main conveying path 11, an alignment unit 5, an identification unit 6 and a front-back reversing mechanism 8 are provided along the sheet conveying direction. At the upstream side of front-back reversing mechanism 8, a rejection unit 7 is connected through a branch path 13.

Alignment unit 5 has a plurality of sensors (not shown) to detect the postures of sheets taken out on main conveying path 11 by take-in unit 4, and the postures of sheets are corrected based on the detection results of the plurality of sensors.

Identification unit 6 has a plurality of sensors to detect various characteristic amounts from sheets of which postures are corrected by alignment unit 5. Destinations of the sheets to be conveyed are decided by the controller of the sheet processing apparatus based on the various characteristic amounts detected by identification unit 6.

Rejection unit 7 is so constructed as to stack sheets judged to be eliminated by identification unit 6. Front-back reversing mechanism 8 is in. the structure with the conveying belt twisted by 180 degree along its running direction and reverses the front-back of sheets.

In lower unit 1b, a plurality of temporary stacking unit 9 and stacking unit 10 are provided to stack sheets conveyed to lower unit 1b through main conveying path 11 from upper unit 1a.

Next, the processing operation of the sheet processing apparatus will be explained.

When sheets are taken out of sheet supply unit 3, these sheets are taken in by take-in unit 4 and supplied to main conveying path 11. The postures of these supplied sheets are corrected by alignment unit 5 and sent to identification unit 6. In this identification unit 6, various characteristic amounts of sheets are detected. Destinations of sheets are decided by a controller that is described later based on these detected data. For example, when sheets are judged to be eliminated, such sheets are conveyed to rejection unit 17 via branching path 13. When judged to be not eliminated, those sheets are conveyed as they are along main conveying path 11. The sheets conveyed along main conveying path 11 are reversed by front-back reversing mechanism 18 or conveyed to a detour 14 without being reversed and sent into lower unit 1b. These sheets are led into temporary stacking unit 9 of a prescribed stacking unit passing through conveying path 12 and classified and stacked.

FIG. 2 is a construction diagram showing the identification unit 6.

In the identification unit 6, the first through the third conveying roller pairs 23a-23c are provided as the conveying means along the conveying direction of sheets P. The rollers of these first through third conveying roller pairs 23a-23c are opposed to each other with main conveying path 11 put between.

Between first conveyor roller pair 23a and second conveying roller pair 23b, a transmitted light sensor 24 and a front side image sensor 25 are arrange opposing to each other with main conveying path 11 put between them. Between second conveying roller pair 23b and third conveying roller pair 23c, a back side image sensor 26 is provided at the back side of main conveying path 11. At the downstream side of third conveying roller pair 23c, a magnetic detection means 17 and a roller 30 are provided opposing to each other with main conveying path 11 put between them.

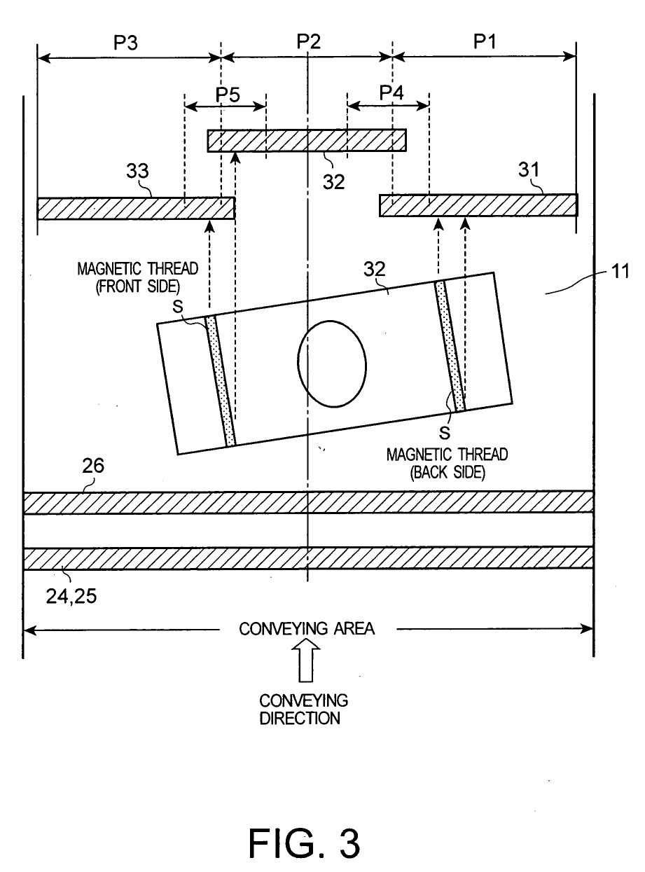

The transmitted light sensor 24 is in the construction so as to detect the end positions of sheets against the conveying reference position (see FIG. 3) along the sheet conveying direction.

These image sensors 25, 26 are composed of array-arranged one-dimensional photodiodes in the construction to read two-dimensional images by conveying sheets P in the direction vertical to the array. This two-dimensional image data is digitized through an A/D converter of a detected data processing unit 28, applied with the image processing and sent to a controller 29 that is a control means.

Controller 29 is so constructed as to compute how far a sheet P is conveyed away from the standard conveying position of the conveying path according to the image data and obtain data of sheet P sensed by a magnetic detection means 27 together with sheet data. Further, magnetic thread positions of various regular sheets are pre-stored in controller 29.

The magnetic detecting means 27 senses the magnetism of the magnetic thread in the state of a sheet P compressed against magnetic detecting means 27 by roller 30.

By the way, a sheet P has a sensory object, for example, a magnetic thread S provided at its one end as shown in FIG. 3.

Further, magnetic detecting means 27 is composed of first through third magnetic thread sensors 31, 32, 33 arranged in the zigzag state extending over the whole width in the direction orthogonal to the sheet conveying direction of the conveying path. The ends of first and second magnetic thread sensors 31 and 32, and the ends of second and third magnetic thread sensors 32 and 33 are provided in the state of overlapped each other along the sheet conveying direction. By this arrangement, it becomes possible to certainly detect magnetic threads S in all areas on sheets P even when the conveying positions of sheets P are somewhat varied.

Further, there is no space among first through third magnetic sensors for sheets to pass through so as to surely detect magnetic threads S even if sheets P are conveyed in the direction diagonally crossing the sheet conveying direction.

Next, the sheet P conveying state and the magnetic thread detecting process in identification unit 6 will be explained.

The postures of sheets P at the time of being conveyed are detected and sheets are judged as being in the conveying area by transmitted light sensor 24 and in succession, tilt, front and back of sheets P are judged by image sensors 25, 26.

Then, the position of magnetic thread S is judged based on the position data (the position data for reference) of magnetic threads of various regular sheets pre-stored and registered in the memory and the right end position data of sheets detected by transmitted light sensor 24.

According to the result of this judgment, it is discriminated as to which area of the detection areas P1˜P5 (see FIG. 3) the magnetic thread S is passing through and a magnetic thread sensor that is able to detect that magnetic thread S is selected.

For example, when the magnetic thread S is discriminated as being at the right side of a sheet P and passing an area P1 as shown in FIG. 3, a first magnetic thread sensor 31 is selected and the magnetic data judging process is made by this first magnetic thread sensor 31.

Further, when a sheet P is in the turned over state and its magnetic thread S is positioned at the left side of the sheet P accordingly and it was judged that the magnetic thread S passed through detection area P5 extending over the detection areas P2 and P3, the magnetic data judging process is made by second and third magnetic sensors 32 and 33.

In the same way, when it is judged that the magnetic thread S passed through the detection area P4 extending over the detection areas P1 and P2, the magnetic data judging process is made by first and second magnetic sensors 31 and 32.

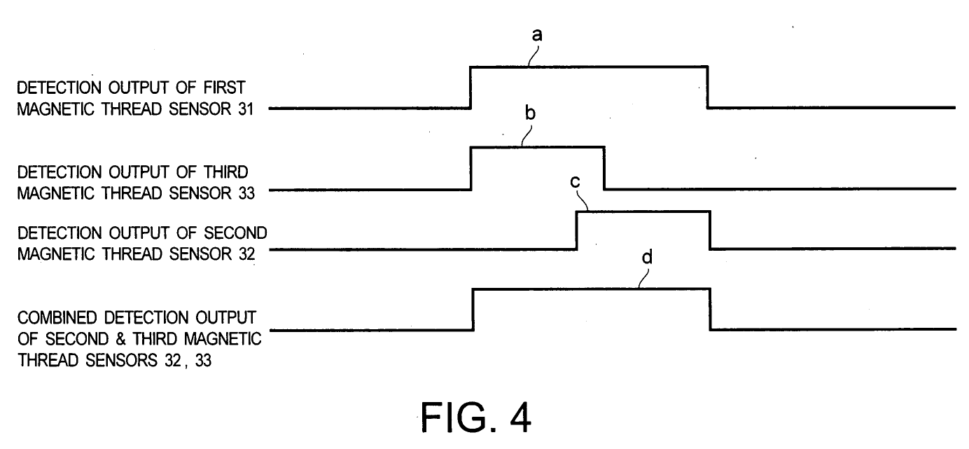

FIG. 4 is a graph showing the detection. outputs of the magnetic threads.

In FIG. 4, the graph a shows the magnetic detection output of first magnetic thread sensor 31, the graph b shows the magnetic detection output of third magnetic thread sensor 33, the graph c shows the magnetic detection output of second magnetic thread sensor 32, and the graph d shows the combined output of second magnetic thread sensor 32 and that of third magnetic thread sensor 33.

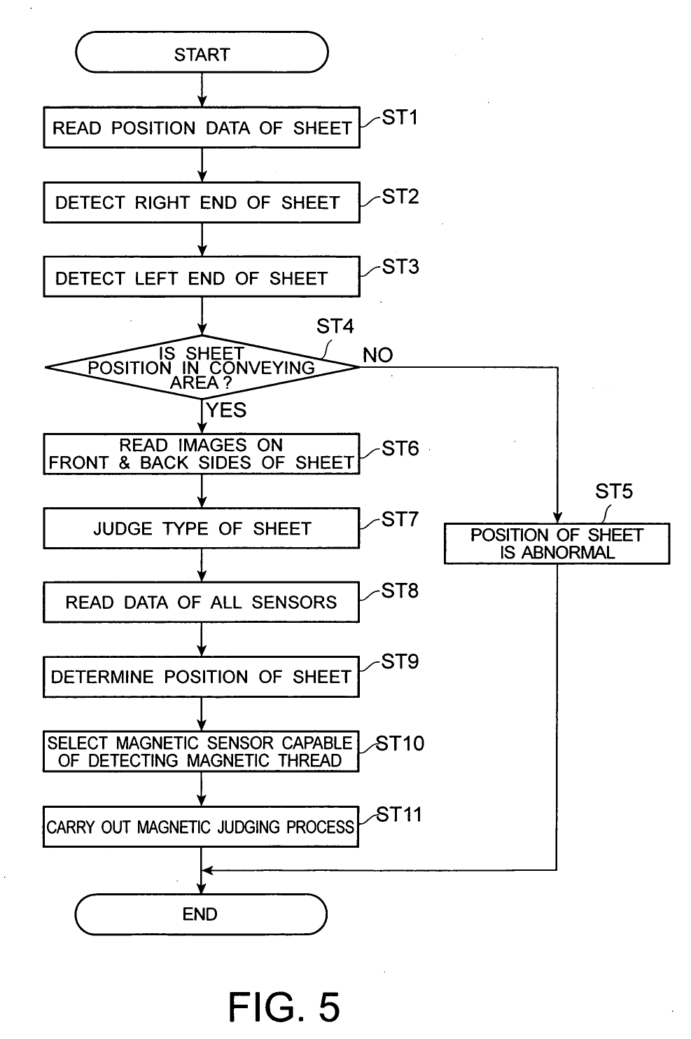

Next, the magnetic thread S detection process operation will be explained with reference to a flowchart shown in FIG. 5.

When a sheet P is put into identification unit 6, the position data of sheet P is first read by transmitted light sensor 24 (Step ST1). Based on this read data, the right end of sheet P is detected (Step ST2). In succession, its left end is detected (Step ST3). Based on the data detected at the right end and the left end, it is judged whether a sheet P is positioned in the conveying area (Step ST4). When the sheet P is judged as being not in the conveying area in Step ST4, the position of the sheet P is judged to be abnormal and the process is terminated (Step ST5).

When a sheet is judge as being in the conveying area, images on the front and back sides are read by front image sensor 25 and back side image sensor 26 (Step ST6). Based on these read data, type of a sheet P, tilt to the conveying direction, variation of front and back are detected and the sheet judging process is made (Step ST7).

Then, reading magnetic data of the sensors (Step ST8), the position of the magnetic thread S is determined based on the magnetic thread position data of sheets pre-stored in the memory and the detected right end position data of the sheet P (Step ST9). Then, magnetic sensors 31-33 that are capable of detecting this determined magnetic thread S are selected (Step ST10). Magnetic data of the magnetic thread S is read by the selected magnetic sensors 31-33 and a magnetic judging process for the sheet is carried out (Step ST11). Thus, it becomes possible to make the stable and detailed magnetic judgment of sheets.

As described above, according to this embodiment, it becomes possible to detect magnetic thread S irrespective of conveying position and tilt of a sheet P because first through third magnetic sensors 31-33 are arranged over the whole. width of conveying path 11 and also it becomes possible to detect magnetic threads of various types of sheets only when positional data of the magnetic threads of various types of sheets are stored in the memory.

Further, because magnetic threads are detected by selecting magnetic sensors S1-S3 that are capable of detecting magnetic treads S of sheets P, it is possible to detect only signals of magnetic threads S precisely without being affected by other magnetic outputs.

Furthermore, when sheets P are provided with metallic threads such as aluminum threads as a sensory object, it is possible to cope with them by replacing first-third magnetic sensors 31-33 with sensors that are capable of detecting metallic sensory objects subject to the detection by aluminum sensors.

According to the present invention, even when sheets are skewed or other than specified sheets or magnetic threads are present on the ends of sheets, it is possible to certainly detect the magnetic threads of such sheets.

Further, needless to say, the present invention is not restricted to the embodiment described above but is applicable by variously modifying without departing from the spirit and the scope of the invention.

While there have been illustrated and described what are at present considered to be preferred embodiments of the present invention, it will be understood by those skilled in the art that various changes and modifications may be made, and equivalents may be substituted for elements thereof without departing from the true scope of the present invention. In addition, many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

What is claimed is:

1. A sheet identification apparatus, comprising:
a conveying means to convey sheets having sensory objects along a conveying path;
a plurality of sensors arranged opposing to each other over almost all width a controller to select a sensory object sensor capable of detecting the sensory object based on the position data detected by the position detecting means and control the selected sensory object sensor so as to detect the sensory object.

2. A sheet identification apparatus as claimed in claim 1, wherein the plurality of sensors are arranged in the state with the ends of the sensors overlapped along the sheet conveying direction.

3. A sheet identification apparatus as claimed in claim 1, wherein
the position detecting means has a transmitted light sensor, a front image sensor and a back side image sensor;
the transmitted light sensor detects the end position of the sheet to the conveying standard along the sheet conveying direction; and
the front image sensor and the back side image sensor detect the tilt, the front and back of the sheet.

4. A sheet identification apparatus as claimed in claim 3, wherein the controller pre-stores position data of sensory objects of various types of regular sheets and determines the position of the sensory object based on the end position of the sheet detected by the transmitted light sensor and the position data of the pre-stored area.

5. A sheet identification apparatus as claimed in claim 1, wherein the sensory object is a magnetic thread and the sensors are magnetic sensors.

6. A sheet identification apparatus as claimed in claim 1, wherein the sensory object is a metallic thread and the sensors are metallic sensors.
